(19) United States
(12) Patent Application Publication
(10) Pub. No.: US 2004/0160517 A1
(43) Pub. Date: Aug. 19, 2004

(54) Image processing system

(75) Inventor: Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/735,924

(22) Filed: Dec. 16, 2003

(30) Foreign Application Priority Data
Feb. 19, 2003 (JP) 2003-40888

(51) Int. Cl. H04N 9/04

(52) U.S. Cl. 348/207.99

(57) ABSTRACT

The present invention has the objective of carrying out correction of undesirable color tone in a pupil region automatically. Each time a correction parameter is determined by an operator carrying out red eye correction processing, a rate of occurrence of red eye regions in respect of each type of camera used for photographing an image, and the correction parameter are stored, as red-eye correction historical information. After the accuracy of the red-eye correction historical information has reached a fixed level or more, the rate of occurrence of red eye regions is determined based on the type of the camera. Searching for a red eye region in an image in which it is determined that a probability of a red eye region occurring is high, and determination of a correction parameter for the red eye region are automatically carried out by a computer.

### CROSS-REFERENCE TO RELATED APPLICATION

This application claims priority under 35 USC 119 from Japanese Patent Application No. 2003-40888, the disclosure of which is incorporated by reference herein.

### BACKGROUND OF THE INVENTION

1. Field of the Invention

The present invention relates to an image processing method, apparatus, and system, and also to a carrier wave. More particularly, the present invention relates to an image processing method for correcting undesirable color tone of a pupil region corresponding to the pupil of an eye of a human being exists in an image, an image processing apparatus to which the image processing method can be applied, and a carrier wave including a data signal which indicates a program for causing a computer to carry out the image processing.

2. Description of the Related Art

When a subject is photographed with a camera, the color tone of the subject on an image recorded by photographing may be greatly different from the actual color tone depending on the state in which light was reflected at the time of photographing. For example, if a human subject is photographed full face with the use of an electronic flash, the light of the electronic flash is made incident, from the front side, on the eyes of the human body in a state in which the pupils are dilated in the dark, and this state is photographically recorded as an image. As a result, there are cases in which a region of the image which corresponds to the pupil (a pupil region) may be colored red (a so-called red eye effect), or may be colored gold (a so-called gold eye effect). This undesirable color tone of the pupil region in the image appears very strange and gives a poor impression. Therefore, various methods have conventionally been proposed in which undesirable color tone of the pupil region is corrected by image processing so that the pupil region looks natural.

For example, Japanese Patent Application Laid-Open (JP-A) No. 2001-186325 discloses a technique in which: data of an image to be processed, in which a pupil region corresponding to the pupil of an eye of a human body and having undesirable color tone such as a red eye effect or a gold eye effect exists, is converted to data of lightness, saturation and hue; an average lightness of an entire image and a lightness of a shadow portion, an average lightness, an average saturation, and an average hue of an analysis region (a region surrounding the pupil region having undesirable color tone) and a lightness of the shadow portion, and an average lightness, an average saturation, and an average hue of the pupil region having undesirable color tone are all respectively calculated; a target lightness of the pupil region having undesirable color tone is set at a value which is equal to or less than the average lightness of the entire image, equal to or less than the lightness of the shadow portion of the analysis region, and also equal to or more than the lightness of the shadow portion of the entire image; a target saturation is set at an intermediate value between the average saturation of the analysis region and zero saturation; a target hue is set at an average hue of the analysis region; and conversion conditions for the pupil region having undesirable color tone are set so that the converted lightness, saturation and hue each coincide with a target value.

However, it is a very complicated matter to execute a series of processing in which searching for a pupil region having undesirable color tone, which region may exist in an image, is carried out, and then, if the pupil region having undesirable color tone is extracted by means of the searching, to correct the undesirable color tone of the pupil region. This series of processing also takes much time, even though there are some differences depending on which processing method among various conventionally proposed methods is applied. Therefore, if the above-described searching and correction were automatically carried out for every one of a large number of images for which photographic processing has been requested by a customer, the processing speed of photographic processing would be significantly reduced. For this reason, in the actual circumstances, the undesirable color tone of the pupil region has been corrected only for images for which correction of the undesirable color tone of the pupil region has been requested by a customer (images in which the presence of a pupil region having undesirable color tone has been detected in advance).

Further, when the correction of undesirable color tone in the pupil region is automated, a parameter for correcting undesirable color tone of the pupil region may not be properly set. For this reason, there are many cases in which setting of the parameter for correcting undesirable color tone of the pupil region, and the like may depend on an operator in the correction of undesirable color tone in the pupil region. In this case, there also exists a drawback in that an operator may be burdened with an excessive amount of labor.

### SUMMARY OF THE INVENTION

The present invention has been achieved in view of the above-described circumstances, and an object thereof is to provide an image processing method, apparatus and system, in which undesirable color tone of a pupil region of an eye of a human subject can be corrected automatically at high speed, and also to provide a carrier wave including a data signal which indicates a program.

The present inventors carried out an operation for analyzing features of a large number of images obtained by photographing subjects with a photographing device, images in which pupil regions having undesirable color tone exist. As a result, it became clear that the rate at which pupil regions having undesirable color tone exist varies greatly depending on the type of photographing device used for photographing. That is, the undesirable color tone of a pupil region is caused by light of an electronic flash specularly reflected by a dilated pupil of an eye of a human subject directly incident on a lens of the photographing device. For example, the more the distance between the lens and the electronic flash device diminishes, the electronic flash light is emitted from a position increasingly close to an optical axis of the lens, and the greater the probability is of the electronic flash light being specularly reflected by the pupil directly incident on the lens.

In this manner, the rate at which undesirable color tone of pupil regions occurs greatly depends on the structure of the photographing device (the positional relationship between the lens and the electronic flash device, on the luminescence intensity of the electronic flash device, and on the like). It can be inferred that a wide difference emerges in the extent to which the pupil region has undesirable color tone, depending on the type of photographing device, and that this stems from the fact that the structure of a photographing device varies according to the type of device. With the size of photographing devices gradually becoming more miniature, the number of photographing devices has increased in which undesirable color tone of the pupil region tends to occur.

In view of the foregoing, a first aspect of the present invention is an image processing apparatus which comprises: a detecting component which detects the type of photographing device in an image to be processed, which image is obtained by photographing a subject using the photographing device; an acquisition component which acquires information corresponding to the type of the photographing device detected by the detecting component from a storage component in which information which indicates a rate of occurrence of a pupil region having undesirable color tone, which information is obtained by correcting undesirable color tone of the pupil region for an image in which the pupil region corresponding to the eye of a human subject and having undesirable color tone exists among a large number of images obtained by photographing the subject using the photographing device, is stored for each type of photographing device; and a processing component which, when it is determined that the probability that the pupil region having undesirable color tone exists in an image to be processed is a predetermined value or more based on the information acquired by the acquisition component, carries out searching for the pupil region having undesirable color tone in the image to be processed and processing of correcting undesirable color tone of the pupil region extracted by the searching.

In the first aspect of the present invention, information which indicates a rate of occurrence of a pupil region having undesirable color tone, which information is obtained by correcting undesirable color tone of the pupil region for an image in which the pupil region corresponding to the pupil of an eye of a human subject and having undesirable color tone exists among a large number of images obtained by photographing the subject using a photographing device, is stored in the storage component for each type of photographing device. For example, a large-capacity storage medium connected to a server which allows communication with the image processing apparatus according to the present invention via a communication network can also be used as the storage component.

Further, in the first aspect of the present invention, the type of the photographing device in the image to be processed, which image is obtained by photographing the subject using the photographing device is detected by the detecting component, and information corresponding to the type of photographing device detected is acquired from the storage component by the acquisition component. When it is determined that the probability that the pupil region having undesirable color tone exists in the image to be processed is a predetermined value or more based on the acquired information, the processing component carries out searching for the pupil region having undesirable color tone in the image to be processed, and correction of undesirable color tone in the pupil region extracted by the searching.

In this manner, in the first aspect of the present invention, the probability that the pupil region having undesirable color tone exists can be properly determined based on the type of the photographing device used for photographing the subject (and also preferably based on a determination as to whether electronic flash light is used or not at the time of photographing). Accordingly, images in which the probability that the pupil region having undesirable color tone exists is a predetermined value or more (that is, images for which a search needs to be made for a pupil region having undesirable color tone, and for which any undesirable color tone of the pupil region extracted by the searching needs to be corrected) can be narrowed down automatically with a high degree of accuracy.

Furthermore, because the number of images to be processed is thus narrowed down, the processing time which can be assigned to each image to be processed increases. Therefore, a relatively high precision technique is applied to the image to be processed although it takes a long processing time, and searching for the pupil region having undesirable color tone and correction of undesirable color tone in the pupil region extracted by the searching can be carried out, thereby allowing correction of the undesirable color tone in the pupil region with a high degree of accuracy. Accordingly, in the first aspect of the present invention, it is possible to carry out correction of undesirable color tone in the pupil region automatically at a high speed.

In the first aspect of the present invention, the storage component further stores therein information which indicates a correction parameter determined so as to correct undesirable color tone of pupil regions in the images in which a pupil region having undesirable color tone exists, for each type of photographic device. The processing component determines, based on the information which indicates the correction parameter acquired by the acquisition component, a correction parameter to be applied to correction of undesirable color tone of pupil regions extracted from images to be processed.

According to the above-described analysis by the present inventors, it has been confirmed that for each type of photographing device, undesirable color tone of the pupil region is characterized by a distinct pattern, and that based on this, the correction parameter for correcting the undesirable color tone of the pupil region is also distinguished by a distinct pattern for each type of photographing device. As described above, the storage component further stores therein, for each type of photographic device, information which indicates a correction parameter determined so as to correct undesirable color tone of the pupil region for the image in which the pupil region having undesirable color tone exists. The processing component is provided so as to determine the correction parameter using the above information. Therefore, it is possible to obtain the correction parameter used to accurately correct the undesirable color tone of the pupil region extracted from the image to be processed, and also carry out correction of the undesirable color tone in the pupil region with a higher degree of accuracy. This eliminates the necessity of relying on an operator to determine the correction parameter.

A second aspect of the present invention is an image processing method which comprises the steps of: storing, for each type of photographing device, information which indicates a rate of occurrence of a pupil region having undesirable color tone and which is obtained by correcting undesirable color tone of the pupil region for an image in which the pupil region corresponding to the eye of a human subject and having undesirable color tone exists among a large number of images obtained by photographing the subject using a photographing device; and detecting the type of the photographing device in an image to be processed, which image is obtained by photographing the subject using the photographing device; acquiring information corresponding to the detected type of photographing device, among information stored in the storage component; and when it is determined that the probability that the pupil region having undesirable color tone exists in the image to be processed is a predetermined value or more based on the information acquired from the storage component, searching for the pupil region having undesirable color tone in the image to be processed and correcting undesirable color tone of the pupil region extracted by the searching.

The information which indicates the rate of occurrence of the pupil region having undesirable color tone, which information is obtained by correcting the undesirable color tone of the pupil region for an image in which the pupil region having undesirable color tone exists, is stored in the storage component for each type of photographing device. In the same manner as in the first aspect, the type of the photographing device in the image to be processed is detected, and information corresponding to the detected type of the photographing device among the information stored in the storage component is acquired. When it is determined that the probability that the pupil region having undesirable color tone exists in the image to be processed is a predetermined value or more based on the acquired information, searching for a pupil region having undesirable color tone in the image to be processed and correction of the undesirable color tone in the pupil region extracted by the searching are carried out. As a result, in the same manner as in the first aspect of the present invention, it becomes possible to correct undesirable color tone of the pupil region automatically at high speed.

In the second aspect of the present invention, it is preferable, for example, to determine a correction parameter for an image in which the pupil region having undesirable color tone exists among a large number of images, correct undesirable color tone of the pupil region using the determined correction parameter, storing information which indicates the determined correction parameter in the storage component for each type of the photographing device, and based on the information indicating the correction parameter and acquired from the storage component, determine a correction parameter applied to correction of undesirable color tone in the pupil region extracted from the image to be processed. As a result, the undesirable color tone of the pupil region can be corrected with a higher degree of accuracy, and determination of the correction parameter does not need to depend on an operator.

In the present invention, the accuracy of determination of a probability that the pupil region having undesirable color tone exists in the image to be processed, or accuracy in determining the correction parameter applied to correction of undesirable color tone in the pupil region extracted from the image to be processed depends on the accuracy of information stored in the storage component. The accuracy of such information can be improved, by storing information obtained along with the correction of undesirable color tone in the pupil region in a larger number of images, or by improving accuracy in the correction of undesirable color tone in the pupil region (for example, accuracy in the determination as to whether a pupil region having undesirable color tone exists or not, and accuracy in determining the correction parameter used to correct undesirable color tone of a pupil region).

On the other hand, until the information stored in the storage component reaches a sufficient degree of accuracy, when it is considered that the accuracy in automatically determining the probability that the pupil region having undesirable color tone exists in the image to be processed, or automatically determining the correction parameter applied to correction of undesirable color tone in the pupil region extracted from the image to be processed is not sufficient even though the present invention is applied, according to the second aspect of the present invention, in the correction of undesirable color tone of the pupil region for an image in which the pupil region having undesirable color tone exists among the large number of images obtained by photographing a subject using the photographing device, an operator is, for example, preferably involved in at least one of the determination as to whether the pupil region having undesirable color tone exists or not, and the determination of a correction parameter for correcting undesirable color tone of the pupil region.

As described above, when an operator is involved in at least one of these determination, that is, the determination as to whether a pupil region exists or not, and the determination of the correction parameter used to correct undesirable color tone of a pupil region, accuracy in the correction of undesirable color tone of the pupil region improves. Therefore, before the information obtained through correction of undesirable color tone in pupil regions is stored in the storage component across a vast number of images, the information stored in the storage component reaches a satisfactory degree of accuracy. Thus, it is possible to complete within a short period of time storage of information in the storage component, which is used to automatically determine a probability that the pupil region having undesirable color tone exists in the image to be processed, or to automatically determine the correction parameter to be applied to correction of undesirable color tone in the pupil region extracted from images to be processed.

Further, in the second aspect of the present invention, it is preferable that, for example, the storage component is connected to a plurality of image processors via the communication line, and information obtained in such a manner that correction of undesirable color tone in the pupil region for an image in which the pupil region having undesirable color tone exists is carried out by each of the plurality of image processors is stored in the storage component.

As a result, compared to a case in which correction of undesirable color tone in the pupil region is carried out by only one image processor and information thus obtained is stored in the storage component, the amount of information obtained through correction of undesirable color tone in the pupil region, which is stored in the storage component per unit time, increases. Thus, the information stored in the storage component reaches a satisfactory degree of accuracy within a short period of time. Accordingly, it is possible to complete within a short period of time, storage in the storage component of information which is used to automatically determine a probability that the pupil region having undesirable color tone exists in the image to be processed, or automatically determine the correction parameter applied to the correction of undesirable color tone in the pupil region extracted from the image to be processed.

A third aspect of the present invention is a computer data signal embodied in a carrier wave, the data signal representing a control program that is readable by a controller of an image processing apparatus, the control program including instructions to: store, in a storage component, information which indicates a rate of occurrence of a pupil region having undesirable color tone, which information is obtained by correcting undesirable color tone of the pupil region for an image in which a pupil region corresponding to the pupil of an eye of a human subject and having undesirable color tone exists among a large number of images obtained by photographing the subject using a photographing device, for each type of photographing device; and detect the type of the photographing device in an image to be processed, which image is obtained by photographing a subject using the photographing device; acquire information corresponding to the detected type of the photographing device, among information stored in the storage component; and when it is determined that the probability that the pupil region having undesirable color tone exists in an image to be processed is a predetermined value or more based on the information acquired from the storage component, search for a pupil region having undesirable color tone in the image to be processed and correct undesirable color tone of the pupil region extracted by the searching.

A fourth aspect of the present invention is an image processing method which comprises the steps of: storing, each time a correction parameter is determined in red eye correction processing for correcting color tone of a red eye region, which processing is carried out by an operator for an image in which the red eye region exists, a rate of occurrence of the red eye region, and the correction parameter as red-eye correction historical information for each type of camera used for photographing the image; making a determination as to whether the accuracy of the red-eye correction historical information is a fixed level or more; and if the red-eye correction historical information is a fixed level or more, recognizing the type of the camera used for photographing an image to be processed, and determining the rate of occurrence of the red eye region based on the red-eye correction historical information corresponding to the recognized camera type, and for an image in which it is determined that the rate of occurrence of the red eye region is high, searching for the red eye region and automatically determining a correction parameter for the red eye region, wherein the red eye region is a pupil region corresponding to the eyes of a human subject and having undesirable color tone.

A fifth aspect of the present invention is an image processing system comprising: a storage component in which information indicating a rate of occurrence of a pupil region having undesirable color tone, which information is obtained by correcting the undesirable color tone of the pupil region for an image in which the pupil region corresponding to the pupil of an eye of a human subject and having undesirable color tone exists among a large number of images obtained by photographing the subject using a photographing device, is stored for each type of photographing device; and an image processor, wherein the image processor includes: a detecting component which detects the type of the photographing device of an image to be processed, which image is obtained by photographing the subject using the photographing device; an acquisition component which acquires, from the storage component, information corresponding to the type of the photographing device detected by the detecting component; and a processing component which, when it is determined that the probability that the pupil region having undesirable color tone exists in an image to be processed is a predetermined value or more based on the information acquired by the acquisition component, carries out searching for the pupil region having undesirable color tone in the image to be processed, and processing for correcting undesirable color tone of the pupil region extracted by the searching.

As described above, in the image processing apparatus according to the present invention, the type of the photographing device used for photographing of an image to be processed is detected, and information corresponding to the detected type of photographing device is acquired from the storage component in which information which indicates a rate of occurrence of a pupil region having undesirable color tone, which information is obtained by correcting undesirable color tone of the pupil region for an image in which the pupil region corresponding to the eye of a human subject and having undesirable color tone exists among a large number of images obtained by photographing using a photographing device, is stored for each type of photographing device, and when it is determined that the probability that the pupil region having undesirable color tone exists in the image to be processed based on the acquired information, searching for the pupil region having undesirable color tone in the image to be processed, and correction of undesirable color tone in the pupil region extracted by the searching are carried out. This makes it possible to carry out correction of undesirable color tone in the pupil region automatically at high speed.

In the image processing method according to the present invention, information which indicates a rate of occurrence of a pupil region having undesirable color tone, which information is obtained by correcting undesirable color tone of the pupil region for an image in which the pupil region corresponding to the eye of a human subject and having undesirable color tone exists among a large number of images obtained by photographing the subject using a photographing device, is stored in the storage component for each type of photographing device; the type of the photographing device used for photographing an image to be processed is detected; information corresponding to the detected type of the photographing device among information stored in the storage component is acquired; and when it is determined that the probability that the pupil region having undesirable color tone exists in an image to be processed is a predetermined value or more based on the information acquired from the storage component, searching for the pupil region having undesirable color tone in the image to be processed and correction of undesirable color tone in the pupil region extracted by the searching are carried out. This makes it possible to carry out correction of undesirable color tone in the pupil region automatically at high speed.

### BRIEF DESCRIPTION OF THE DRAWINGS

FIG. 1 is a block diagram which schematically shows the structure of a photographic processing system according to a first embodiment of the present invention.

FIG. 2 is a flow chart which shows details of red-eye manual correction processing.

FIG. 3 is an image diagram which shows an example of a red-eye manual correction viewing screen.

FIGS. 4A and 4B are image diagrams which show methods for designating an eye region in each of the processing modes of the red-eye manual correction processing.

FIG. 5 is a flow chart which shows details of red-eye automatic correction processing.

FIG. 6 is a block diagram which schematically shows the structure of a photographic processing system according to a second embodiment of the present invention.

### DETAILED DESCRIPTION OF THE INVENTION

Referring now to the attached drawings, examples of embodiments of the present invention will be described in detail.

### First Embodiment

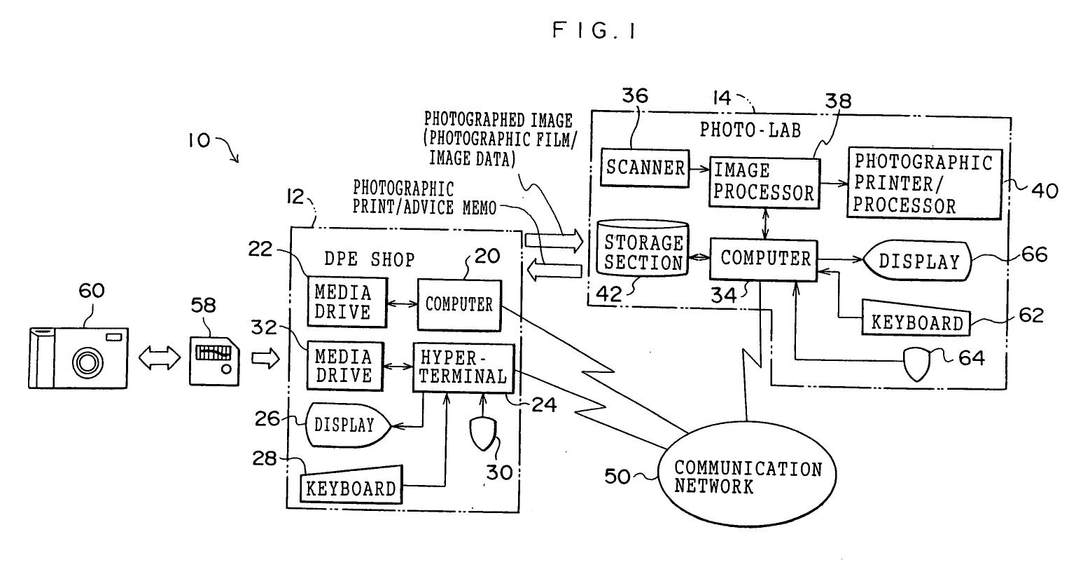

In FIG. 1, a photographic processing system 10 according to a first embodiment of the present invention is shown. Connected to the photographic processing system 10 according to the first embodiment of the present invention are a plurality of DPE shops 12 provided in various regions, which accept orders from customers for photographic processing such as preparation of photographic prints, and a plurality of photo labs 14 in which the photographic processing requested by customers via the DPE shops 12 is carried out. The DPE shops 12 each have a computer 20 operated by clerks at the DPE shop 12, and a hyper-terminal 24 operated by customers coming to the DPE shops 12, which are both installed therein. A media drive 22 is connected to the computer 20.

In the present embodiment, three types of order modes for photographic processing received from customers are provided. The first order mode is a mode in which a subject is photographed by a customer using a digital still camera designed for exclusive use photographing, a digital video camera or a digital still camera attached to a portable device such as a mobile phone or PDA (all of which will be generically referred to as DSC; by way of example, DSC to which the present invention is applied is shown in FIG. 1 by reference number “60”), to thereby allow image data to be recorded (as an image file of EXIF format or the like) on a recording media 58 (for example, smart media (R), compact flash (R) or memory stick (R)), which is shown in the shape of a smart media (R) in FIG. 1, and the recording media 58 is handed in by a customer as an order for photographic processing.

A media drive 22 has the function of carrying out reading and writing of information for various recording media 58. Further, the computer 20 to which the media drive 22 is connected is connected to (a computer 34, which will be described below, of) the photo lab 4 via a communication network 50. When an order for photographic processing based on the first order mode is given, the DPE shop 12 accepts an order for photographic processing by receiving the recording media 58 handed in by a customer, and reads out image data (an image file) of photographed images from the received recording media 58 using the media drive 22, and transmits the readout image data to the photo lab 14 by the computer 20. In this manner, the DPE shop 12 issues an instruction to the photo lab 14 to carry out photographic processing for which an order is accepted from the customer.

Further, in the second order mode, an order for photographic processing is given in such a manner that image data (for example, an image file of EXIF format or the like) obtained by photographing a subject by a customer using a DSC is transmitted to the DPE shop 12 via a computer network such as the Internet. The computer 20 has the function of transmitting and receiving information via the Internet or the like. When an order for photographic processing based on the second order mode is given, the DPE shop 12 accepts an order for photographic processing in such a manner that image data of a photographed image transmitted from a customer via the Internet or the like is received by the computer 20, and the received image data is further transmitted to the photo lab 14 by the computer 20. In this manner, the DPE shop 12 issues an instruction to the photo lab 14 to carry out photographic processing for which an order has been accepted from the customer.

Moreover, in the third order mode, an order for photographic processing is given in such a manner that a photographic film exposed to record an image thereon by a customer's photographing a subject with a camera is handed to the DPE shop 12. When an order for photographic processing based on the third order mode is given, the DPE shop 12 accepts an order for photographic processing by receiving the photographic film handed from the customer, and delivers the received photographic film to the photo lab 14. In this manner, the DPE shop 12 issues an instruction to the photo lab 14 to carry out photographic processing for which an order has been accepted from the customer.

Further, the hyper-terminal 24 installed at the DPE shop 12 is comprised of a personal computer (PC) in which a CPU, an ROM, an RAM, and an input/output port are connected together via a bus. Each connected to the input/output port are a hard disk drive (HDD), a display 26 for displaying an image and the like, a keyboard 28, a mouse 30 and a media drive 32. The media drive 32 has the function of carrying out reading and writing of information for various recording media 58 in the same manner as in the media drive 22. Further, the hyper-terminal 24 is also connected to the communication network 50.

The photo lab 14 has a computer 34, a scanner 36, an image processor 38 and a photographic printer/processor 40, which are installed therein. The computer 34 and the image processor 38 correspond to the image processing apparatus according to the present invention. The computer 34 is structured such that a CPU, a ROM, a RAM and an input/output port are connected together via a bus, and various peripheral equipment is connected to the input/output port. The peripheral equipment connected to the input/output port includes a keyboard, a display, a mouse, and a hard disk drive (HDD). The computer 34 receives image data of photographed images transmitted from the DPE shop 12 when an order for photographic processing based on the first or second order mode is given, and outputs the received image data to the image processor 38.

Further, a photographic film which is delivered from the DPE shop 12 when an order for photographic processing based on the third order mode is given, and on which an image recorded by exposure after development processing and the like is made visible, is set in the scanner 36. The scanner 36 reads an image recorded on the set photographic film (an image which is made visible after development processing and the like), and outputs image data obtained by the reading to the image processor 38.

In the image processor 38, predetermined image processing is carried out for image data inputted from the scanner 36 or the computer 34. In the photographic printer/processor 40, preparation of photographic prints is carried out using image data subjected to the image processing in the image processor 38 (exposure-recording of an image on photographic printing paper by scanning, on the photographic printing paper, laser light modulated in accordance with an image to be recorded, development of photographic printing paper on which an image is recorded by exposure, and the like) is carried out. A display 66 for presenting an image to an operator, a keyboard 62 and a mouse 64 which are used by an operator to input optional information are connected to the computer 34, and image data which is to be subjected to the image processing in the image processor 38 is temporarily transferred to the computer 34. The type of image processing for the image data and processing conditions thereof are determined by the computer 34.

The computer 34 is connected to the communication network 50, and allows communication with the hyper-terminal 24 of the DPE shop 12 and the computer 44 (described below) of the data center 16 via the communication network 50. Further, connected to the computer 34 is a storage section 42 comprised of an HDD or the like, in which red eye correction historical information (described below in detail) is stored. The storage section 42 stores therein a red-eye manual correction program used to carry out red-eye manual correction processing (described below) by the computer 34, and an red-eye automatic correction program used to carry out red-eye automatic correction processing (described below) by the computer 34. The red-eye automatic correction program mentioned herein corresponds to the program of the present invention.

Next, the operation of the first embodiment will be described. In the present embodiment, the image processing to be carried out by the image processor 38 includes red eye correction processing for correcting undesirable color tone of a red eye region for image data of an image in which a pupil region corresponding to the pupil of an eye of a human subject and having undesirable color tone such as a red eye effect or a gold eye effect (hereinafter referred to as a red eye region) exists.

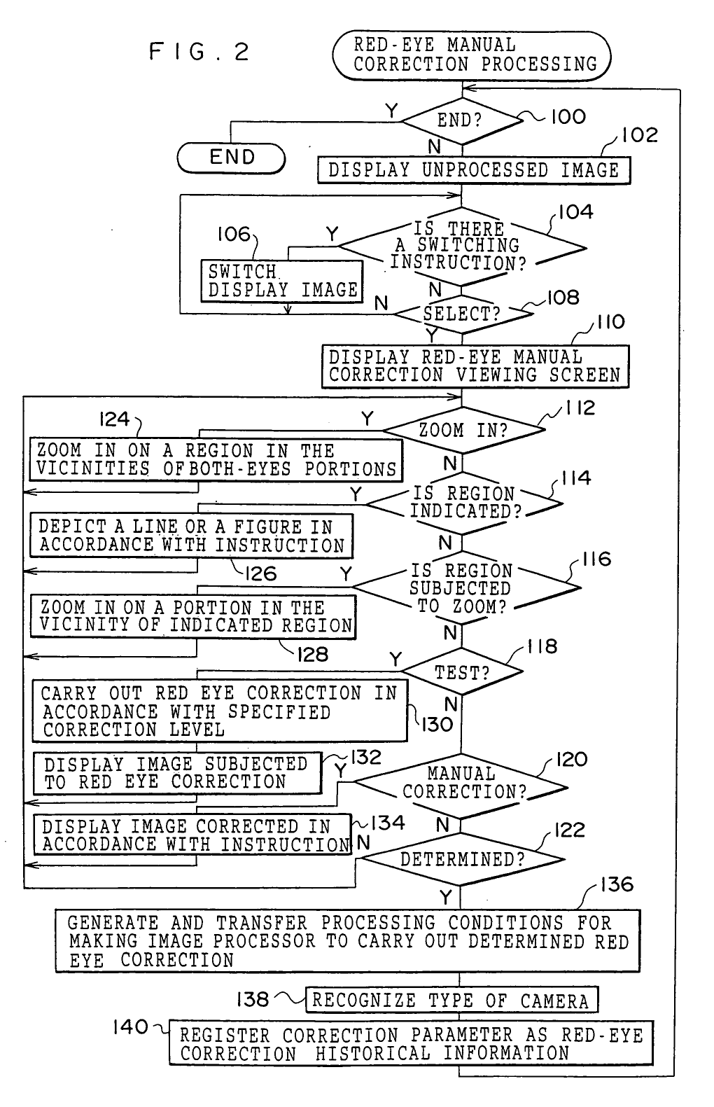

As the red eye correction processing is carried out, red eye correction historical information is gradually accumulated and stored in the storage section 42 (described in detail below). After the precision of red eye correction historical information reaches a fixed level, the red eye correction processing is automatically carried out based on the red eye correction historical information accumulated and stored in the storage section 42 (red-eye automatic correction processing described below). However, until the precision of red eye correction historical information accumulated and stored in the storage section 42 reaches the fixed level, the red eye correction is carried out by red-eye manual correction processing in which a determination of processing conditions for the red eye correction processing is made by an operator. The red-eye manual correction processing will be hereinafter described with reference to the flow chart of FIG. 2.

The red-eye manual correction processing is realized in such a manner that, in a state in which, for example, an image for which red eye correction has been requested by a customer is selected in advance as an image to be processed (alternatively, an image photographed with electronic flash light may also be selected as the image to be processed), the red-eye manual correction program is executed by the CPU of the computer 34 in accordance with an instruction from an operator to carry out the red-eye manual correction.

In step 100, it is determined whether red-eye manual correction processing is terminated or not by making a determination as to whether images selected in advance for processing have been all processed, or whether an operator's instruction to terminate the processing has been given or not. If the decision of step 100 is negative, the process proceeds to step 102, in which image data of a single image which is not processed is fetched from images to be processed, and an image represented by the fetched image data is displayed on the display 66.

In step 104, it is determined whether or not an instruction has been given for the switching of an image displayed on the display 66. If the decision of step 104 is negative, the process proceeds to step 108, in which it is determined whether the image displayed on the display 66 has been selected as an image to be subjected to red eye correction. If the decision of step 108 is also negative, the process returns to step 104, and steps 104 and 108 are repeated until such time as the determination in any one of these steps becomes affirmative.

When an image is displayed on the display 66, the operator visually observes the displayed image, and examines whether a red eye region exists in the displayed image. This examination corresponds to the “determination as to whether a pupil region having undesirable color tone exists or not” in which the operator is involved in the present invention. In circumstances where no red eye region has been found to exist, the operator gives an instruction to switch the display of the image shown on the display 66 by operating the keyboard 62 or the mouse 64. As a result, the decision of step 104 is affirmative and the process proceeds to step 106, in which image data of another image which is not processed is fetched from images to be processed, and is displayed as an image on the display 66. In this manner, the image shown on the display 66 is changed into another image, and the process returns to step 104.

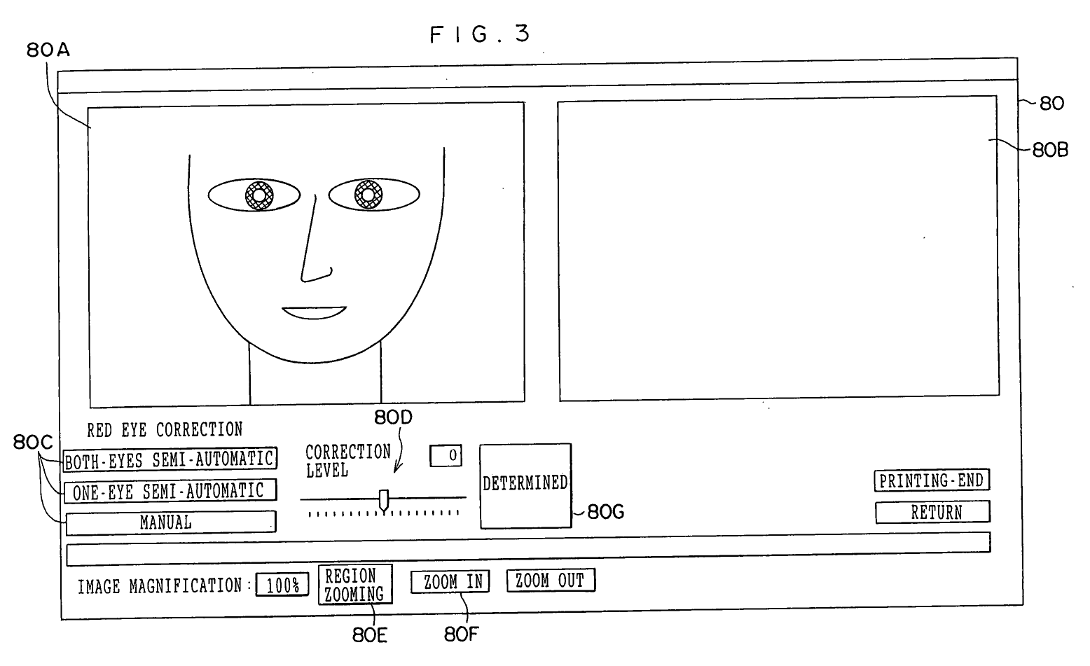

Further, when a red eye region has been found to exist in an image shown on the display 66 by operating the keyboard 62 or the mouse 64, the operator gives an instruction to select the image shown on the display 66 as an image to be subjected to red eye correction. As a result, the decision of step 108 is affirmative and the process proceeds to step 110, in which a red-eye manual correction viewing screen 80 as shown in FIG. 3 is shown on the display 66.

The red-eye manual correction viewing screen 80 includes a display area 80A used to display an image subject to the red eye correction, and a display area 80B used to display an image subjected to the red eye correction. The selected image subject to the red eye correction is shown in the display area 80A. Further, the red-eye manual correction viewing screen 80 also includes a plurality of buttons 80C used to select various processing modes of red eye correction, a slide bar 80D used to adjust a correction level of the red eye correction, a button 80E used to give an instruction for zooming in on a region, a button 80F used to indicate zoom-in, a button 80G used to indicate determination of testing and processing, and the like.

In the present embodiment, as the processing mode of red eye correction in the red-eye manual correction processing, a “both-eyes semiautomatic mode” in which undesirable color tone generated in both eyes of a human subject is automatically corrected, a “one-eye semiautomatic mode” in which undesirable color tone generated in one of the eyes is automatically corrected, and a “manual mode” in which undesirable color tone is corrected manually by an operator are provided. The red-eye manual correction viewing screen 80 includes buttons 80C which correspond to these three processing mode, respectively.

When an image subject to the red eye correction is displayed in the display area 80A, the operator visually observes the displayed image subject to the red eye correction, determines a processing mode suitable for the image subject to the red eye correction, and selects the button 80C corresponding to the determined processing mode with a click of the mouse 64. In this manner, selection of the processing mode suitable for the red eye correction of the image subject to red eye correction is carried out. Further, when the “both-eyes semiautomatic mode” or “one-eye semiautomatic mode” is selected as the processing mode, the operator further determines a correction level suitable for the image subject to the red eye correction, and in accordance with the determined correction level, operates the slide bar 80D via the mouse 64 (this operation corresponds to that the “determination of a correction parameter used to correct undesirable color tone of a pupil region” in which an operator is involved). In this manner, the correction level suitable for the red eye correction of the image subject to red eye correction is also adjusted.

In the subsequent steps 112 through 122, an instruction by the operator is determined. In step 112, it is determined whether an instruction to carry out zoom-in has been given by the operator. If the decision of step 112 is negative, the process proceeds to step 114, in which it is determined whether a red eye region has been indicated by the operator. If the decision of step 114 is negative, the process proceeds to step 116 in which it is determined whether an instruction to zoom in on the red eye region is given by the operator. If the decision of step 116 is also negative, the process proceeds to step 118, it is determined whether testing has been indicated by the operator. If the decision of step 118 is also negative, the process proceeds to step 120, in which it is determined whether manual correction is carried out by the operator. If the decision of step 120 is also negative, the process proceeds to step 122 in which whether determination of the processing has been indicated. If the decision of step 122 is also negative, the process returns to step 112 and steps 112 through 122 are repeated until such time as the determination in any one of the steps becomes affirmative.

When a red eye effect is corrected manually, first, the operator operates to select the button 80F with a click of the mouse 64, thereby giving an instruction to carry out zoom-in (displaying a close-up of the vicinities of the both eyes of a subject in an image subject to the red eye correction). As a result, the decision of step 112 is affirmative and the process proceeds to step 124, in which a region, which corresponds to the both eyes of a subject in the image subject to red eye correction, is estimated, and the estimated region and its vicinities are zoomed in over the entire surface of the display area 80A. Thereafter, the process returns to step 112.

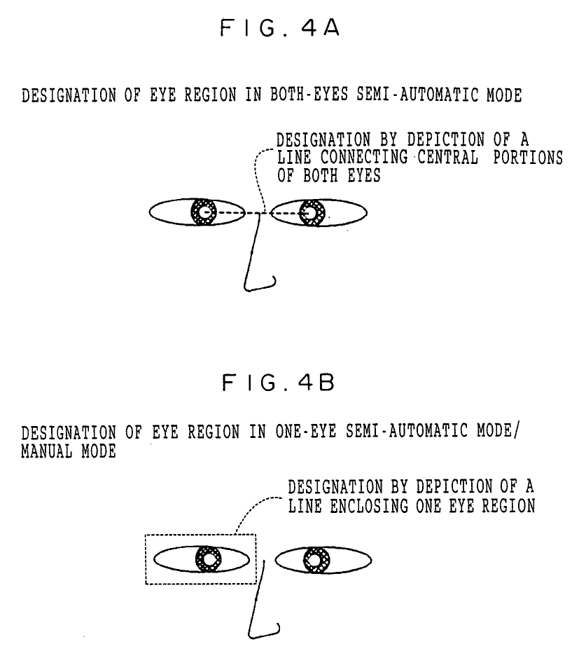

When the region in the vicinities of both eyes of a subject in the image subject to the red eye correction is zoomed in on, the operator indicates the red eye region by operating the mouse 64 so as to make the computer 34 to recognize a red eye region in the image subject to the red eye correction. The method for indicating the red eye region varies depending on each processing mode of red eye correction. In for instance the “both-eyes semiautomatic mode”, as shown in FIG. 4A, a straight line which connects respective central portions of the pupil regions of the eyes in an image displayed on the display area 80A (an image in which the region in the vicinities of the both eyes is zoomed in on) is depicted on the displayed image, and the red eye region is thus indicated. Further, for instance in the “one-eye semiautomatic mode” and “manual mode”, as shown in FIG. 4B for instance, the red eye region is indicated by depicting, on the displayed image, a rectangle which encloses one eye region including the red eye region within the displayed image. When the above-described indication is made by the operator, the decision of step 114 is affirmative, and the process proceeds to step 126, in which a line or a rectangular figure is depicted on an image shown on the display area 80A in accordance with the operator's instruction. Thereafter, the process returns to step 112.

When it is confirmed by the operator that the line or figure has been depicted on the image shown on the display area 80A as instructed, the operator selects the button 80E with a click of the mouse 64, thereby giving an instruction to carry out zooming in on the indicated region. As a result, the decision of step 116 is affirmative, and the process proceeds to step 128, in which the region indicated by the operator (the red eye region and its vicinities) is zoomed in on the display area 80A. Thereafter, the process returns to step 112.

When the red eye region and its vicinities are zoomed in on the display area 80A and the “both-eyes semiautomatic mode” or the “one-eye semiautomatic mode” is previously selected as the processing mode of red eye correction, the operator selects the button 80D with a click of the mouse 64 so as to give an instruction to carry out the red eye correction (testing). As a result, the decision of step 118 is affirmative, and the process proceeds to step 130, in which the red eye correction is carried out in which undesirable color tone is automatically corrected in accordance with the previously-designated correction level for the red eye region which is recognized based on a line or the position of a figure depicted in accordance with the operator's instruction. One of any various well known processing methods can be applied to the red eye correction. For example, a processing method disclosed in JP-A No. 2001-186325 may also be used. When the red eye correction is completed, the process proceeds to step 132, in which an image which has been subjected to the red eye correction is shown on the display area 80B, and an image before subjected to the red eye correction is shown on the display area 80A. Thereafter, the process returns to step 112.

On the other hand, in cases in which the “manual mode” is selected as the processing mode of red eye correction, if the red eye region and its vicinities are zoomed in on the display region 80A, the operator carries out a manual operation for correcting undesirable color tone of the red eye region by operating the keyboard 62 and the mouse 64. This operation is carried out in the following manner: a color to be coated over the red eye region is determined by selecting a desired color, for example, either from a palette in which multiple color samples are listed, or from the image subject to red eye correction; a range in which the determined color needs to be coated is designated within the red eye region; the position of catch light (a portion which looks shiny due to reflecting light from outside) within the designated range is set; and thereafter, the button 80G is selected with a click of the mouse 64 so as to instruct to carry out the red eye correction (testing).

When the above-described operation is carried out, the decision of step 120 is affirmative and the process proceeds to step 134, in which based on the operator's instruction, the color designated by the operator is coated on the region designated by the operator to be within the range for coating, and red eye correction is carried out, in which luminance transition corresponding to catch light is produced at the position set by the operator, and the image which has been subjected to the red eye correction is shown in the display area 80B, and an image yet to be subjected to red eye correction is shown on the display area 80A. Thereafter, the process returns to step 112.

If the image which has been subjected to red eye correction is shown on the display area 80B, the operator visually observes the image shown on the display area 80B, and inspects the result of red eye correction. If it is determined that the result of red eye correction is not adequate, the operation for altering the processing conditions is carried out (for example, if the “both-eyes semiautomatic mode” or “one-eye semiautomatic mode” is set, the correction level is adjusted, and if the “manual mode” is set, at least one of color, range of coating and the position of catch light is altered) and the red eye correction is carried out once again. Further, if it is determined that a red eye effect is properly corrected, the operator gives an instruction to determine the conditions of red eye correction for an image subject to the red eye correction by selecting the button 80G with the click of the mouse 64.

As a result, the decision of step 122 is affirmative and the process proceeds to step 136, in which processing-condition information for making the image processor 38 to carry out the red eye correction for which processing conditions are determined, is generated, and the generated processing-condition information is transferred to the image processor 38 in such a manner as to correspond to information used to identify an image subject to the red eye correction. In the image processor 38, based on the processing-condition information transferred from the computer 34, it is recognized that the red eye correction processing needs to be carried out for an image to be processed. When the image processing is carried out for the image to be processed, the red eye correction processing is carried out under the processing conditions defined by the transferred processing-condition information. As a result, a photographic print which has been subjected to the red eye correction (undesirable color tone of the pupil region is corrected) is prepared from image data of the image subject to the red eye correction.

In the subsequent step 138, the type of camera used when an image subject to the red eye correction was photographed is recognized and it is confirmed whether or not electronic flash light is used at the time of photographing. For example, when an order for photographic processing has been accepted from a customer based on the first order mode or the second order mode, exposed images are handed in by the customer in the form of an image file. The image file includes attribute information for each exposed image such as the type of DSC used for photographing. Therefore, the type of camera can be recognized by reference to the attribute information.

Further, even when the order for photographic processing has been accepted from the customer based on the third order mode, if an APS film has been used as the photographic film, various information is recorded on a magnetic layer of the APS film. Therefore, the type of camera used for photographing can be recognized by reading information recorded on the magnetic layer. Some of highly functional silver-salt cameras of a single lens reflex type include the function of recording various information in a built-in memory. This type of camera employs a structure in which photographing information recorded in the built-in memory and exposed images (a photographic film) are made to correspond to each other due to ID which is optically written in a portion of the photographic film other than the exposed image area. Even in the case of an image photographed with this type of camera, the type of camera used for photographing can be recognized by utilizing information recorded in the built-in memory.

As shown in Table 1 below, the storage section 42 according to the first embodiment has a region for storing as red-eye correction historical information in respect of each type of camera used for photographing, the number of times of selection for each processing mode in the red eye correction, and the number of times of selection for each level of the correction level in the both-eyes semiautomatic mode and the one-eye semiautomatic mode. In this manner, the storage section 42 corresponds to a storage component according to the present invention. As shown in Table 1, the correction level is comprised of three stages, and the number of times of selection for each stage is measured. However, the number of stages in the correction level is not limited to the example in Table 1. For example, the number of stages in the correction level may be further increased.

TABLE 1
Examples of contents of red-eye correction historical information:

| | | | | Correction | | | | |
|---|---|---|---|---|---|---|---|---|
| | | | | level | | | | |
| | | | | in both-eyes/ | | | | |
| | Number of times of | | | One-eye | | | Number | |
| | selecting processing | | | Semiautomatic | | | of images | Rate of |
| | mode | | | mode | | Total | for which | occurrence |
| | both- | one- | | | number | number | electronic | of |
| Type of | eye | eye | | | of | of | flash was | red eye |
| camera | automation | automation | manual | level | times | images | used | effect |
| Company | 5 | 10 | 3 | (15) | 2 | 50 | 20 | 18/20 = 90% |
| “F” | | | | (20) | 3 | | | |
| Model “A” | | | | (45) | 10 | | | |
| . | . | . | . | . | . | . | . | . |
| . | . | . | . | . | . | . | . | . |
| . | . | . | . | . | . | . | . | . |

In the subsequent step 140, red-eye correction historical information corresponding to the type of camera recognized in step 138 is updated in accordance with the processing modes of red eye correction for an image subject to the red eye correction for which processing conditions are determined (and the correction levels in the both-eyes semiautomatic mode and the one-eye semiautomatic mode). Thereafter, the process returns to step 100. The red eye manual correction processing is repeated until the decision of step 100 is affirmative. Therefore, each time a specific image is selected as one subject to the red eye correction, the “number of times of selecting processing mode” (and the “correction level”) corresponding to the type of camera used for photographing of the image is updated in accordance with the processing mode and the correction level for the image, which are selected and determined by the operator.

As is also seen from Table 1, the red-eye correction historical information also includes, for each type of camera, a region provided to store the “total number of images”, that is, the total number of images processed by the image processor 38, the “number of images in which electronic flash was used”, that is, the total number of images photographed with an electronic flash among all the images processed by the image processor 38, and the “rate of occurrence of a red eye effect”, which corresponds to the ratio of images subject to the red eye correction in relation to the total number of images photographed with an electronic flash.

The “total number of images” and the “number of images in which an electronic flash was used” are both appropriately updated during the processing, apart from during the above-described red-eye manual correction processing, thus determining the processing conditions for image processing, other than red eye correction, of each of the images to be processed by the image processor 38. The determination as to whether an electronic flash was used at the time of photographing can be made by referring to the above-described attribute information attached to the image file. Further, the “rate of occurrence of red eye effect” may be updated when the “number of times of selecting the processing mode” (and the “correction level”) of red eye correction historical information is updated in the red-eye manual correction processing (FIG. 2), that is, when step 140 is carried out. Alternatively, the “rate of occurrence of red eye effect” may also be updated when the “total number of images” and “number of images in which an electronic flash was used” of the red-eye historical information are updated.

Due to each item of the red-eye correction historical information being appropriately updated as described above, a large number of images are processed in the image processor 38, and the processing conditions of the red eye correction are determined for an image in which undesirable color tone is caused in the pupil region, and the red eye correction processing is carried out for the image. As a result, the “rate of occurrence of red eye effect” of the red-eye correction historical information becomes a value which properly reflects the rate at which undesirable color tone is generated in the pupil region, which rate varies depending on the type of camera. Further, the “number of times of selecting the processing mode” and the “correction level” of the red-eye correction historical information also become data which reflect an appropriate processing parameter in the red eye correction, which parameter varies depending on the type of camera.

When the “manual mode” is selected as the processing mode of the red eye correction, the automatic correction in step 130 described above is not carried out, nor is the adjustment of the correction level carried out by the operator. Therefore, the “correction level” of the red-eye correction historical information is not updated, but the “number of times of selecting the processing mode” is updated, and based on the updating, the “rate of occurrence of red eye effect” is also updated. This makes contribution to improvement in the precision of “rate of occurrence of red eye effect”.

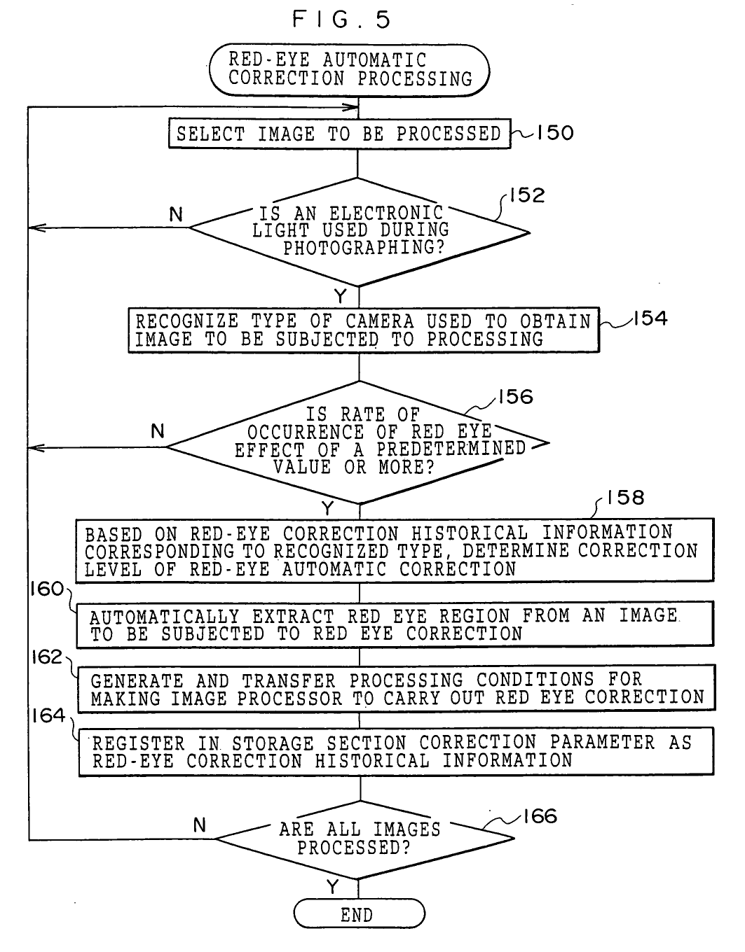

Accordingly, in the present embodiment, after the precision of the red-eye correction historical information has reached a certain level, in place of the above-described red-eye manual correction processing, red-eye automatic correction processing shown in FIG. 5 is carried out. A determination as to whether or not the precision of the red-eye correction historical information has reached a certain level can be made based on, for example, a determination as to whether or not the “total number of images” of the red-eye correction historical information, or the total number of images which have been subjected to the red eye correction (that is, a sum of images for each processing mode in the “number of times of selecting the processing mode”) has reached a predetermined value or more. Alternatively, the determination as to the precision of the red-eye correction historical information may also be made by the operator.

In the above-described red-eye manual correction processing, images in which an order for red eye correction has been given by a customer have been described as images subject to red eye correction. However, in the red-eye automatic correction processing, images subject to image processing in the image processor 38 are all made into ones subject to the red eye correction. In step 150, from among a group of images to be processed, a single image is selected as one to be processed. In step 152, by referring to attribute information of an image file of the image which is selected as one to be processed, and the like, it is determined whether or not the image to be processed is an image photographed using electronic flash light.

When the decision of step 152 is negative, the process returns to step 150, in which another image is selected as the next one to be processed. When the decision of step 152 is affirmative, the process proceeds to step 154, in which with reference to attribute information of an image file of the image to be processed, and the like, the type of a camera used in photographing the image to be processed is recognized. This step 154 corresponds to a detecting component according to the present invention. In step 156, among the red-eye correction historical information stored in the storage section 42, with reference to the “rate of occurrence of red eye effect” of the red-eye correction historical information corresponding to the type of camera recognized in step 154 (this operation corresponds to an acquisition component according to the present invention), it is determined whether or not a probability that a red eye effect occurs in an image obtained by photographing using an electronic flash in this type of camera (that is, the “rate of occurrence of red eye effect”) is a predetermined value or more. When the decision of step 156 is negative, it can be determined that the possibility that undesirable color tone of the pupil region may be caused in an image to be processed is low. Therefore, the process returns to step 150 without carrying out any more processing.

On the other hand, when the decision of step 156 is affirmative since the rate of occurrence of red eye effect is a predetermined or more, for example, as shown by “the rate of occurrence of red eye effect=90%” in Table 1, the image to be processed is regarded as an image subject to the red eye correction, and step 158 and subsequent steps are carried out. The processing subsequent to step 158 corresponds to a processing component according to the present invention along with the image processor 38 in which the red eye correction processing is practically carried out.

In other words, in step 158, based on the “correction level” of red-eye correction historical information which corresponds to the type of camera recognized in the above-described step 154, the correction level in the red eye automatic correction is determined. As the correction level in the red eye automatic correction, for example, a weighted average value of each level in the “correction level” of the red-eye correction historical information can be used in which the number of times of selection for each level is used as weight. As an example, in Table 1 above, “level 15” was selected twice, “level 20” is selected three times, and “level 45” was selected ten times. The sum of number of times of selecting the processing mode is 18 (=5+10+3). In accordance with the following equation, the initial value of the correction level can be set at “30”.

(15×2+20×3+45×10)÷18=30

As described above, by determining the correction level using the red-eye correction historical information, an appropriate correction level can be obtained, corresponding to the type of camera used for photographing can be obtained.

In step 160, a red eye region is automatically extracted from an image subject to the red eye correction. There exist various algorithms as an algorithm used to automatically extract the red eye region. However, in the red-eye automatic correction processing according to the present embodiment, based on the type of camera used for photographing, and based on the determination as to whether an electronic flash was used at the time of photographing, the number of images subject to the red eye correction is narrowed down. Therefore, an algorithm which allows high-precision extraction of a red eye region can be used as the above-described algorithm, though it takes relatively much time for the processing.

In step 162, the processing-condition information which allows the image processor 38 to carry out the red eye correction at the correction level determined in step 158 is generated for the red eye region extracted by the processing of step 160, and the generated processing-condition information is transferred to the image processor 38 in such a manner as to correspond to information used to identify an image subject to the red eye correction. As a result, in the image processor 38, the red eye correction processing is carried out for the image subject to the red eye correction under the processing condition defined by the transferred processing-condition information.

In step 164, the red-eye correction historical information corresponding to the type of camera recognized in step 154 is updated in accordance with the processing condition for the image subject to the red eye correction. In the subsequent step 166, it is determined whether the processing of step 150 has been carried out for all the images to be processed. When the decision of step 166 is negative, the process returns to step 150 and the processing subsequent to step 150 is repeated for all the images to be processed (that is, all images which are subjected to image processing in the image processor 38). When the decision of step 166 is affirmative, the red-eye automatic correction processing is terminated.

Due to the above-described red-eye automatic correction processing, the red eye correction processing can be automatically carried out not only for images for which an order for red eye correction has been given from a customer, but also for images in which there is a strong possibility that undesirable color tone may be caused in the pupil region (that is, images in which the rate of occurrence of red eye effect is a predetermined value or more) without causing deterioration in the processing ability of the photographic processing system 10. Further, it is possible to reduce the burden placed on an operator.

### Second Embodiment

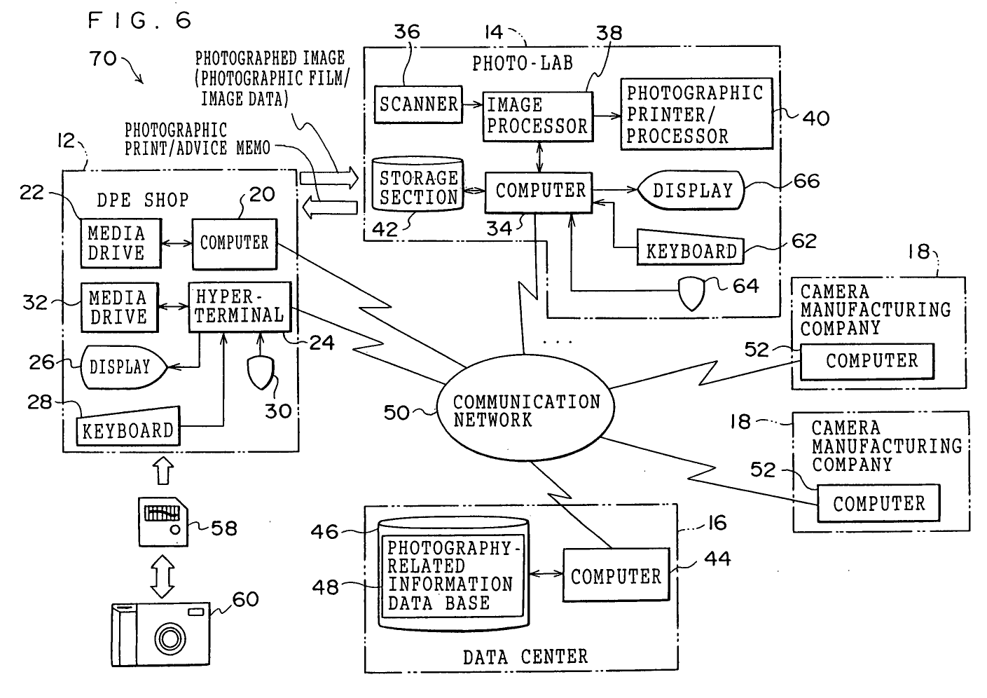

Next, the second embodiment of the present invention will be described. Note that the same portions as those of the first embodiment will be denoted by the same reference numerals, and a description thereof will be omitted. As shown in FIG. 6, in a photographic processing system 70 according to the second embodiment of the present invention, a data center 16 in which various information relating to photographic processing is controlled in a centralized manner, and a plurality of camera manufacturing companies which produces cameras used by customers at the time of photographing are connected via the communication network 50.

The data center 16 has a computer 44 and a large-capacity storage device 46 comprised of an HDD and the like, which are installed therein. The computer 44 is connected to the communication network 50 to allow communication with the computer 34 installed in each of the plurality of photo labs 14 and also with a computer 52 provided in each of the plurality of camera manufacturing companies 18 via the communication network 50. Further, the storage device 46 is provided with photography-related information database (DB) 48 in which various information relating to photographic processing is stored. The storage device 46 is connected to the computer 44, and writing and reading of information for the photography-related information DB 48 is carried out by the computer 44.

Next, the operation of the second embodiment will be described. In the above-described first embodiment, the red-eye correction historical information is stored in the storage section 42 of each photo lab 14 by the computer 34 of each photo lab 14. However, in the photographic processing system 70 according to the second embodiment, the red-eye correction historical information is controlled by the data center 16 (that is, the information is stored in the photography-related information DB 48), and used by the computer 34 of each photo lab 14 connected to the communication network 50.

In other words, each time that a situation occurs in which red-eye correction historical information needs to be updated (for example, the processing conditions of red eye correction for an image subject to the red eye correction is determined by the red-eye manual correction processing or red-eye automatic correction processing, or the number of images (an integrated value) photographed with electronic flash light among images to be processed by the image processor 38 changes by a predetermined value, or the like), the computer 34 provided at each of the photo labs 14 transmits information which requests updating of a corresponding data item among the red-eye correction historical information, to the computer 44 of the data center 16, and the computer 44 updates the red-eye correction historical information stored in the photography-related information DB 48 in accordance with the request received from the computer 34.

In this manner, the red-eye correction historical information stored in the photography-related information DB 48 is updated in accordance with the result of red eye correction in the plurality of photo labs 14 in which the respective computers 34 are connected to the communication network 50. Therefore, the amount of information stored as the red-eye correction historical information per unit time period increases, and the red-eye correction historical information stored in the photography-related information DB 48 reaches a satisfactory level of precision within a short period of time. The storage device 46 in which the photography-related information DB 48 (red-eye correction historical information) is stored corresponds to a storage component according to the present invention.

Further, the computer 34 at each of the photo labs 14 makes reference to the red-eye correction historical information stored in the photography-related information DB 48 at the time of carrying out the red-eye automatic correction processing. As described above, in the second embodiment, the red-eye correction historical information reaches a satisfactory level of precision within a short period of time. Therefore, it is possible to change from the red-eye manual correction processing to the red-eye automatic correction processing in each of the photo labs 14 in early stages. Accordingly, the burden imposed on operators in each of the photo labs 14 can be further reduced.

Further, a camera in which a red eye effect is apt to occur can be identified for each type of camera by making reference to the red-eye correction historical information. In the second embodiment, the computer 44 of the data center 16 which controls the red-eye correction historical information is connected via the communication network 50 to the computer 52 of each camera manufacturing company 18. Therefore, for example, the computer 44 of the data center 16 refers to the red-eye correction historical information, and can transmit advisory information such as a message to the effect that “the camera “***” of your company has a tendency to generate a red eye effect”, to the computer 52 of a camera manufacturing company 18 which produced cameras in which the rate of occurrence of red eye effect has reached a predetermined value or more. As a result, in the camera manufacturing company 18, based on the received advisory information, improvements can be made to camera products which are of a type in which it is suggested that the red eye effect is apt to occur, and the advisory information can also be utilized by the company in the design of the subsequent model of camera.

In the foregoing, as the red-eye automatic correction processing (FIG. 5), processing in which the red eye correction is carried out completely automatically (where an operator is not required) was described. However, the present invention is not limited to the same. A determination may be made by the operator as to whether the ultimate processing conditions for red eye correction are appropriate, in such a manner that, for example, an image in a case in which an initial value of the correction parameter is calculated and the red eye correction is carried out based on the calculated correction parameter is presented to the operator, and if the operator gives an instruction, the processing conditions such as the correction parameter are corrected.

Further, in the foregoing, the computer 34 and the image processor 38 installed in the photo lab 14 were described as an example of the image processing apparatus according to the present invention. However, the present invention is not limited to the same. For example, due to a photographing device having the function as the image processing apparatus according to the present invention, the photographing device can be made to function as the image processing apparatus according to the present invention.

What is claimed is:

1. An image processing system comprising:
a storage component in which information indicating a rate of occurrence of a pupil region having undesirable color tone, which information is obtained by correcting the undesirable color tone of the pupil region for an image in which the pupil region corresponding to the pupil of an eye of a human subject and having undesirable color tone exists among a large number of images obtained by photographing the subject using a photographing device, is stored for each type of photographing device; and
an image processor,
wherein the image processor includes:
a detecting component which detects the type of the photographing device of an image to be processed, which image is obtained by photographing the subject using the photographing device;
an acquisition component which acquires, from the storage component, information corresponding to the type of the photographing device detected by the detecting component; and
a processing component which, when it is determined that the probability that the pupil region having undesirable color tone exists in an image to be processed is a predetermined value or more based on the information acquired by the acquisition component, carries out searching for the pupil region having undesirable color tone in the image to be processed, and processing for correcting undesirable color tone of the pupil region extracted by the searching.

2. The image processing system of claim 1, wherein:
the storage component further stores therein information which indicates a correction parameter determined so as to correct undesirable color tone of the pupil region for the image in which the pupil region having undesirable color tone exists, for each type of photographic device; and
the processing component determines, based on the information which indicates the correction parameter acquired by the acquisition component, a correction parameter applied to correction of undesirable color tone in the pupil region extracted from the image to be processed.

3. The image processing system of claim 1, wherein the storage component is connected to a plurality of image processors via a communication line, and stores therein information obtained in such a manner that correction of undesirable color tone in the pupil region for an image in which the pupil region having undesirable color tone exists is carried out by each of the plurality of image processors.

4. The image processing system of claim 1, wherein the undesirable color tone is one of a red eye effect and a gold eye effect, which occurs in the pupil region of an image in such a manner that, when a human subject is photographed in a full-faced manner using electronic flash light, the electronic flash light is made incident from the front side and regularly reflected by the eye portions of the human subject whose pupils are dilated in the dark.

5. An image processing apparatus comprising:
a detecting component which detects the type of a photographing device in an image to be processed, which image is obtained by photographing a subject using the photographing device;
an acquisition component which acquires information corresponding to the type of the photographing device detected by the detecting component, from a storage component in which information which indicates a rate of occurrence of a pupil region having undesirable color tone, which information is obtained by correcting undesirable color tone of the pupil region for an image in which the pupil region corresponding to the pupil of an eye of a human subject and having undesirable color tone exists among a large number of images obtained by photographing the subject using a photographing device, is stored for each type of photographing device; and
a processing component which, when it is determined that the probability that the pupil region having undesirable color tone exists in an image to be processed is a predetermined value or more based on the information acquired by the acquisition component, carries out searching for the pupil region having undesirable color tone in an image to be processed and processing for correcting undesirable color tone of the pupil region extracted by the searching.

6. The image processing apparatus of claim 5, wherein:
the storage component further stores therein information which indicates a correction parameter determined so as to correct undesirable color tone of the pupil region for the image in which the pupil region having undesirable color tone exists, for each type of photographic device; and
the processing component determines, based on the information which indicates the correction parameter acquired by the acquisition component, a correction parameter applied to correction of undesirable color tone in the pupil region extracted from the image to be processed.

7. The image processing apparatus of claim 5, wherein the undesirable color tone is one of a red eye effect and a gold eye effect, which occurs in the pupil region of an image in such a manner that, when a human subject is photographed in a full-faced manner using electronic flash light, the electronic flash light is made incident from the front side and regularly reflected by the eye portions of the human subject whose pupils are dilated in the dark.

8. An image processing method comprising:
storing, each time a correction parameter is determined in red eye correction processing for correcting color tone of a red eye region, which processing is carried out by an operator for an image in which the red eye region exists, a rate of occurrence of the red eye region, and the correction parameter as red-eye correction historical information for each type of camera used for photographing the image;
making a determination as to whether the accuracy of the red-eye correction historical information is a fixed level or more; and
if the red-eye correction historical information is a fixed level or more, recognizing the type of the camera used for photographing an image to be processed, and determining the rate of occurrence of the red eye region based on the red-eye correction historical information corresponding to the recognized camera type, and for an image in which it is determined that the rate of occurrence of the red eye region is high, searching for the red eye region and automatically determining a correction parameter for the red eye region,
wherein the red eye region is a pupil region corresponding to the eyes of the human subject and having undesirable color tone.

9. An image processing method comprising the steps of:
storing, in a storage component, information which indicates a rate of occurrence of a pupil region having undesirable color tone, which information is obtained by correcting undesirable color tone of the pupil region for an image in which a pupil region corresponding to the eye of a human subject and having undesirable color tone exists among a large number of images obtained by photographing the subject using a photographing device, for each type of photographing device; and
detecting the type of the photographing device of an image to be processed, which image is obtained by photographing a subject using the photographing device;
acquiring information corresponding to the detected type of the photographing device, among information stored in the storage component; and
when it is determined that the probability that the pupil region having undesirable color tone exists in an image to be processed is a predetermined value or more based on the information acquired from the storage component, searching for a pupil region having undesirable color tone in the image to be processed and correcting undesirable color tone of the pupil region extracted by the searching.

10. The image processing method of claim 9, further comprising the steps of:
determining a correction parameter for the image in which the pupil region having undesirable color tone exists among a large number of images, and correcting undesirable color tone of the pupil region using the determined correction parameter, and further storing information indicating the determined correction parameter in the storage component for each type of photographing device; and
based on the information indicating the correction parameter and acquired from the storage component, determining a correction parameter applied to correction of undesirable color tone in the pupil region extracted from the image to be processed.

11. The image processing method of claim 9, wherein in the correction of undesirable color tone in the pupil region for the image in which the pupil region having undesirable color tone exists among the large number of images, at least one of a determination as to whether the pupil region having undesirable color tone exists or not, and a determination of a correction parameter for correcting undesirable color tone of the pupil region is carried out by an operator.

12. The image processing method of claim 9, wherein the storage component is connected to a plurality of image processors via a communication line, and stores therein information obtained in such a manner that correction of undesirable color tone in the pupil region for an image in which the pupil region having undesirable color tone exists is carried out by each of the plurality of image processors.

13. The image processing method of claim 9, wherein the undesirable color tone is one of a red eye effect and a gold eye effect, which occurs in the pupil region of an image in such a manner that, when a human subject is photographed in a full-faced manner using electronic flash light, the electronic flash light is made incident from the front side and regularly reflected by the eye portions of the human subject whose pupils are dilated in the dark.

14. A computer data signal embodied in a carrier wave, the data signal representing a control program that is readable by a controller of an image processing apparatus, the control program including instructions to:
store, in a storage component, information which indicates a rate of occurrence of a pupil region having undesirable color tone, which information is obtained by correcting undesirable color tone of the pupil region for an image in which a pupil region corresponding to the eye of a human subject and having undesirable color tone exists among a large number of images obtained by photographing the subject using a photographing device, for each type of photographing device; and
detect the type of the photographing device in an image to be processed, which image is obtained by photographing a subject using the photographing device;
acquire information corresponding to the detected type of the photographing device among information stored in the storage component; and
when it is determined that the probability that the pupil region having undesirable color tone exists in an image to be processed is a predetermined value or more based on the information acquired from the storage component, search for a pupil region having undesirable color tone in the image to be processed and correct undesirable color tone of the pupil region extracted by the searching.

15. The data signal of claim 14, wherein the carrier wave is stored in a recording medium.
